(19) United States
(12) Patent Application Publication
(10) Pub. No.: US 2009/0135100 A1
(43) Pub. Date: May 28, 2009

(54) Plasma display device and driving method thereof

(76) Inventors: Seung-Min Kim, Suwon-si (KR); Woo-Joon Chung, Suwon-si (KR); Tae-Seong Kim, Suwon-si (KR); Jun-Ho Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/292,740

(22) Filed: Nov. 25, 2008

(30) Foreign Application Priority Data
Nov. 26, 2007 (KR) 10-2007-0120989

(51) Int. Cl. G09G 3/28

(52) U.S. Cl. 345/60; 315/169.4; 345/212

(57) ABSTRACT

A method of driving a frame of plasma display device having a first electrode, a second electrode, and an address electrode, the method including gradually decreasing a voltage of the second electrode from a second voltage to a third voltage and, while decreasing the voltage of the second electrode, supplying a vertical synchronization pulse and applying a first voltage to the first electrode, after the voltage of the second electrode reaches the third voltage, gradually increasing the voltage of the second electrode from a fifth voltage to a sixth voltage while a fourth voltage is applied to the first electrode, and, after the voltage of the second electrode reaches the sixth voltage, gradually decreasing the voltage of the second electrode from an eighth voltage to a ninth voltage while a seventh voltage is applied to the first electrode.

### BACKGROUND OF THE INVENTION

1. Field of the Invention

Embodiments relate to a plasma display device and a driving method thereof.

2. Description of the Related Art

A plasma display device is a display device that uses a plasma display panel (PDP) for displaying characters or images using plasma that is generated by a gas discharge.

One frame of the display may be divided into a plurality of subfields so as to drive the plasma display device, and grayscales may be displayed using a combination of weight values of subfields. A cell may be initialized by a reset discharge during a reset period of each subfield. Light emitting cells and non-light emitting cells may be selected by an address discharge during an address period. In addition, sustain discharges may be generated a number of times during a sustain period, the number of times corresponding to a weight value of a corresponding subfield.

In order to initialize a cell during the reset period, a voltage of a scan electrode may be gradually increased while a sustain electrode and an address electrode are maintained at a predetermined voltage (e.g., a 0V voltage), after which another predetermined voltage (e.g., a voltage that is higher than the 0V voltage) may be applied to the sustain electrode, and the voltage of the scan electrode may be gradually decreased.

In the reset period described above, a discharge firing voltage between the sustain electrode and the scan electrode may be higher than a discharge firing voltage between the address electrode and the scan electrode. Accordingly, when the voltage of the scan electrode is gradually increased, a discharge between the address electrode and the scan electrode may be generated before a discharge between the sustain electrode and the scan electrode.

When the discharge between the address electrode and the scan electrode is generated first, a strong discharge may be generated during the reset period. Excess wall charges may be formed on the respective electrodes by the strong discharge, and many priming particles may be generated. Further, wall charges between the sustain electrode and the scan electrode may not be sufficiently eliminated, and a misfiring discharge may result. In addition, a contrast ratio may be reduced by the strong discharge during the reset period.

The description of the related art provided above is not prior art, but is merely a general overview that is provided to enhance an understanding of the art, and does not necessarily correspond to a particular structure or device.

### SUMMARY OF THE INVENTION

Embodiments are therefore directed to a plasma display device and a driving method thereof, which substantially overcome one or more of the problems due to the limitations and disadvantages of the related art.

It is therefore a feature of an embodiment to provide a plasma display device and a driving method thereof, in which a preset period overlaps with an idle period.

It is therefore another feature of an embodiment to provide a plasma display device and a driving method thereof, in which a display electrode is floated during a preset period.

At least one of the above and other features and advantages may be realized by providing a method of driving a frame of plasma display device having a first electrode, a second electrode, and an address electrode, the method including gradually decreasing a voltage of the second electrode from a second voltage to a third voltage and, while decreasing the voltage of the second electrode, applying a first voltage to the first electrode during a first period, after the voltage of the second electrode reaches the third voltage, gradually increasing the voltage of the second electrode from a fifth voltage to a sixth voltage while a fourth voltage is applied to the first electrode during a second period, and, after the voltage of the second electrode reaches the sixth voltage, gradually decreasing the voltage of the second electrode from an eighth voltage to a ninth voltage while a seventh voltage is applied to the first electrode during a third period. An absolute value of the difference between the first voltage and the third voltage may be greater than an absolute value of the difference between the seventh voltage and the ninth voltage, and a fourth period between a point of time for finishing a sustain period of a last subfield of a first frame and a starting point of a vertical synchronization signal for a second frame that is subsequent to the first frame is overlapped with the first period.

The fourth period comprises a part of the first period. The fourth period comprises the first period. The voltage of the second electrode may be at the third voltage during the vertical synchronization pulse. A slope of the voltage decrease from the second voltage to the third voltage may be less than a slope of the voltage decrease from the eight voltage to the ninth voltage.

The method may further include intermittently floating the second electrode while decreasing the voltage of the second electrode from the second voltage to the third voltage. The method may further include, after the voltage of the second electrode reaches the ninth voltage, applying a scan pulse to the second electrode while applying an address pulse to the address electrode.

At least one of the above and other features and advantages may also be realized by providing a plasma display device, including a first electrode, a second electrode, and an address electrode, a controller configured to drive a frame and to provide a vertical synchronization pulse for indicating a start of the frame, and one or more drivers configured to drive the first electrode, the second electrode, and the address electrode. A voltage of the second electrode may gradually decrease from a second voltage to a third voltage and, while the voltage of the second electrode decreases, a first voltage may be applied to the first electrode during a first period, after the voltage of the second electrode reaches the third voltage, the voltage of the second electrode may gradually increase from a fifth voltage to a sixth voltage while a fourth voltage is applied to the first electrode, after the voltage of the second electrode reaches the sixth voltage, the voltage of the second electrode may gradually decrease from an eighth voltage to a ninth voltage while a seventh voltage is applied to the first electrode, an absolute value of the difference between the first voltage and the third voltage may be greater than an absolute value of the difference between the seventh voltage and the ninth voltage, and a second period between a point of time for finishing a sustain period of a last subfield of a first frame and a starting point of a vertical synchronization pulse for a second frame that is subsequent to the first frame is overlapped with the first period.

The second period comprises a part of the first period. The second period comprises the first period. The voltage of the second electrode may be at the third voltage during the vertical synchronization pulse. A slope of the voltage decrease from the second voltage to the third voltage may be less than a slope of the voltage decrease from the eight voltage to the ninth voltage.

The second electrode may be intermittently floating while decreasing the voltage of the second electrode from the second voltage to the third voltage. After the voltage of the second electrode reaches the ninth voltage, a scan pulse may be applied to the second electrode while applying an address pulse to the address electrode.

At least one of the above and other features and advantages may also be realized by providing a plasma display device, including a discharge cell, a controller configured to drive a frame and to provide a vertical synchronization pulse for the frame, and one or more drivers configured to apply a reset waveform to the discharge cell during a reset period of an initial subfield of the frame, and to apply a predetermined waveform to the discharge cell during a first period before the reset period. A third wall charge on the discharge cell may be eliminated after a first wall charge is formed on the discharge cell by the predetermined waveform, a second wall charge may be formed on the discharge cell by the reset waveform when the discharge cell is sustain discharged in a last subfield of an immediately preceding frame, and a second period before the vertical synchronization signal for the first frame may overlap with the first period.

A first electrode, a second electrode, and an address electrode may correspond to the discharge cell. The predetermined waveform may include a gradual decrease in a voltage of the second electrode from a second voltage to a third voltage, a first voltage being applied to the first electrode while the voltage of the second electrode decreases

The second period comprises a part of the first period. The second period comprises the first period. The voltage of the second electrode may be at the third voltage during the vertical synchronization pulse. During the reset period, after the voltage of the second electrode reaches the third voltage, a gradual increase in the voltage of the second electrode from a fifth voltage to a sixth voltage while a fourth voltage is applied to the first electrode; and after the voltage of the second electrode reaches the sixth voltage, a gradual decrease in the voltage of the second electrode from an eighth voltage to a ninth voltage while a seventh voltage is applied to the first electrode, an absolute value of the difference between the first voltage and the third voltage being greater than an absolute value of the difference between the seventh voltage and the ninth voltage, and a slope of the voltage decrease from the second voltage to the third voltage may be less than a slope of the voltage decrease from the eight voltage to the ninth voltage.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates a diagram of a plasma display device according to an embodiment;

FIG. 2 illustrates a diagram of one cycle of a vertical synchronization signal applied to the plasma display device of FIG. 1;

FIG. 3 illustrates driving waveforms of the plasma display device shown in FIG. 1 wherein a falling waveform is applied to a Y electrode during a preset period;

FIG. 4 and FIG. 5 illustrate driving waveforms of the plasma display device shown in FIG. 1 wherein a falling waveform is applied to a Y electrode during an idle period and a preset period, respectively; and

FIG. 6A and FIG. 6B illustrate diagrams of a falling waveform applied to the Y electrode when the Y electrode is periodically floated.

### DETAILED DESCRIPTION OF THE INVENTION

Korean Patent Application No. 10-2007-0120989, filed on Nov. 26, 2007, in the Korean Intellectual Property Office, and entitled: “Plasma Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. In the drawing figures, like reference numerals refer to like elements throughout.

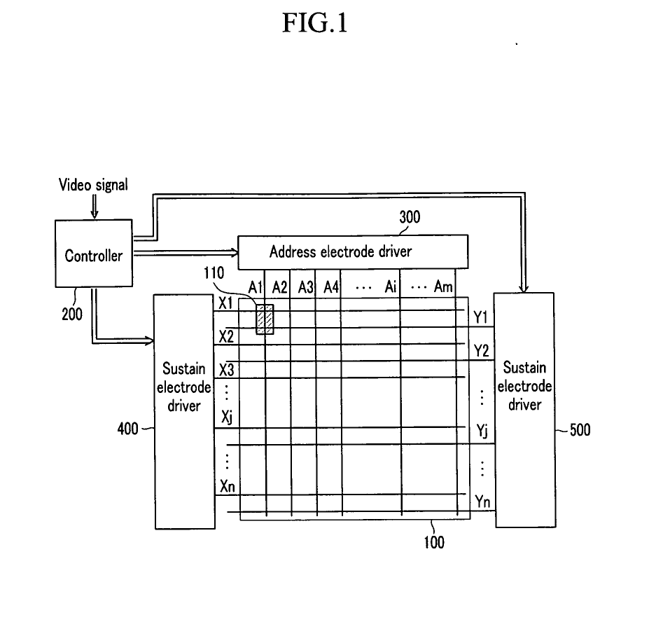

FIG. 1 illustrates a diagram of a plasma display device according to an embodiment. Referring to FIG. 1, the plasma display device may include a plasma display panel (PDP) 100, a controller 200, an address electrode driver 300, a sustain electrode driver 400, and a scan electrode driver 500.

The PDP 100 may include a plurality of address electrodes A1 . . . Ai . . . Am, i.e., A1 to Am (m is an integer, and i is an integer between 1 and m; the address electrodes may be collectively referred to as “A electrodes”). The A electrodes may extend in a column direction.

The PDP 100 may also include pluralities of sustain electrodes X1 . . . Xj . . . Xn, i.e., X1 to Xn, and scan electrodes Y1 . . . Yj . . . Yn, i.e., Y1 to Yn (n is an integer, and j is an integer between 1 and n; the sustain and scan electrodes may be collectively referred to as “X electrodes” and “Y electrodes,” respectively). The X electrodes and Y electrodes may extend in a row direction in pairs. The X electrodes X1 to Xn may be formed corresponding to the Y electrodes Y1 to Yn, respectively. The X electrodes and Y electrodes may perform a display operation for displaying an image during the sustain period.

The Y electrodes Y1 to Yn and the X electrodes X1 to Xn may cross the A electrodes A1 to Am. Discharge spaces corresponding to crossing regions of the A electrodes A1 to Am and the X and Y electrodes X1 to Xn and Y1 to Yn may form discharge cells 110 (hereinafter referred to as “cells”).

The above construction of the PDP 100 is only an example, and PDPs having different structures may be employed as well.

The controller 200 may receive an external video signal and may output driving control signals for the A electrodes A1 to Am, the X electrodes X1 to Xn, and the Y electrodes Y1 to Yn.

The address electrode driver 300 may apply a driving voltage to the plurality of address electrodes A1 to Am according to the driving control signal from the controller 200.

The scan electrode driver 400 may apply a driving voltage to the plurality of scan electrodes Y1 to Yn according to the driving control signal from the controller 200.

The sustain electrode driver 500 may apply a driving voltage to the plurality of sustain electrodes X1 to Xn according to the driving control signal from the controller 200.

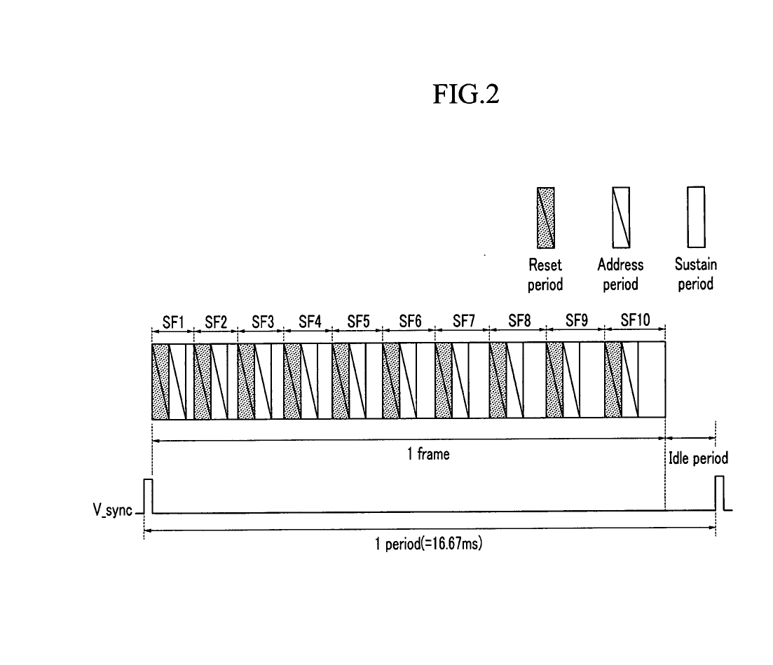

FIG. 2 illustrates a diagram of one cycle of a vertical synchronization signal applied to the plasma display device of FIG. 1. Referring to FIG. 2, a vertical synchronization signal V_sync may be a timing signal input from an external source. A high level signal V_sync may be output for each frame, and the signal V_sync may be used to separate each frame. In the system established by the National Television System Committee (NTSC), a frequency period of the vertical synchronization signal V_sync is 16.67 ms ( 1/60 sec). One cycle period of the vertical synchronization signal V_sync may include a driving period of one frame of the video signal and an idle period.

In driving the PDP 100, one frame of the driving period may be divided into a plurality of subfields respectively having weight values. Each subfield may include a reset period, an address period, and a sustain period. In FIG. 2, it is illustrated that one frame is divided into 10 subfields, although this is merely an example.

In FIG. 2, the vertical synchronization signal V_sync is indicated as being aligned with the beginning of the reset period for the first subfield SF1. However, FIG. 2 is not intended to illustrate the exact positioning of the vertical synchronization signal V_sync. Rather, details of the positioning of the vertical synchronization signal V_sync according to embodiments are described below.

The idle period may be a margin period for preventing an erroneous operation resulting from an abnormal period of the vertical synchronization signal V_sync. The idle period may be denoted as a period between a finishing point of the sustain period of a last subfield in a frame (e.g., an n^{th} frame) and a point just before the vertical synchronization signal for starting of a next frame (e.g., an n+1^{th} frame) is applied.

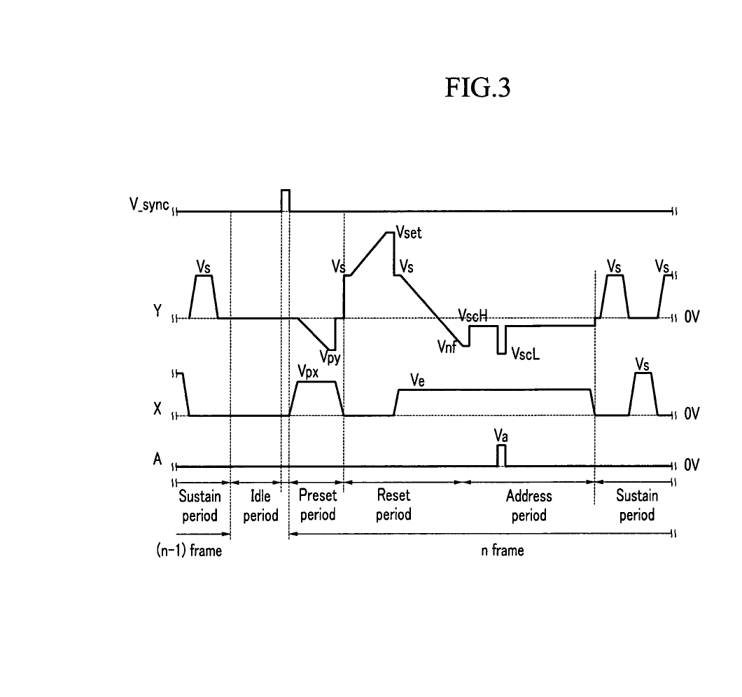

FIG. 3 illustrates driving waveforms of the plasma display device shown in FIG. 1 wherein a falling waveform is applied to a Y electrode during a preset period. Referring to FIG. 3, during a preset period before a rising period of the reset period, the sustain electrode driver 500 may apply a first voltage Vpx to the X electrode. Also during the preset period and before the rising period of the reset period, the scan electrode driver 400 may gradually decrease the voltage of the Y electrode from a second voltage, e.g., 0V, to a third voltage Vpy. At the same time, the address electrode driver 300 may apply a reference voltage, e.g., 0V, to the A electrode.

A difference between voltages described above that are applied to the X electrode and the Y electrode during the preset period may satisfy Equation 1:

|VPx−Vpy|>|Ve−Vnf| Equation 1

The voltage difference |Ve−Vnf| may be set to be close to a discharge firing voltage Vfxy between the X and Y electrodes, and the wall voltage between the X and Y electrodes may become close to the 0V voltage. Positive wall charges (+) may be formed on the Y electrode and the negative wall charges (−) may be formed on the X electrode when the voltage difference |Vpx−Vpy| is greater than the voltage difference |Ve−Vnf|.

Subsequently, during the reset period, the sustain electrode driver 400 may bias the X electrode to a fourth voltage, e.g., the reference voltage 0V. The address electrode driver 300 may also bias the A electrode to the reference voltage, 0V. Additionally, during the reset period the scan electrode driver 500 may gradually increase the voltage of the Y electrode from a fifth voltage Vs to a sixth voltage Vset.

As shown in FIG. 3, the voltage of the Y electrode may increase in a ramp pattern from Vs to Vset during the reset period. The Vset voltage may be set to be higher than a discharge firing voltage between the X and Y electrodes so that discharges are generated in all the cells. While the voltage of the Y electrode increases, a weak discharge may be generated between the Y and X electrodes, and between the Y and A electrodes. Accordingly, negative wall charges (−) may be formed on the Y electrode, and positive wall charges (+) may be formed on the X and A electrodes.

Subsequently, during a later portion of the reset period, the sustain electrode driver 400 may bias the X electrode to a seventh voltage Ve. During this time, the scan electrode driver 500 may gradually decrease the voltage of the Y electrode from an eighth voltage, e.g., the Vs voltage, to a ninth voltage Vnf.

As shown in FIG. 3, the voltage of the Y electrode may decrease in a ramp pattern from Vs to Vnf during the reset period. A weak discharge may be generated between the Y and X electrodes, and between the Y and A electrodes, while the voltage of the Y electrode decreases. Accordingly, the negative wall charges (−) previously formed on the Y electrode and the positive wall charges (+) previously formed on the X and A electrodes may be eliminated.

The Ve voltage and the Vnf voltage may be set so that a wall voltage between the Y and X electrodes is close to the 0V voltage, and the sustain discharge is not generated during the sustain period in a cell that is not selected during the address period following the reset period. The voltage difference |Ve−Vnf| may be set close to the discharge firing voltage between the Y electrode and the X electrode.

Conventionally, if wall voltages between the X and Y electrodes, and between the A and Y electrodes, become close to the 0V voltage, a strong discharge may be generated during a reset period of a subsequent subfield. In particular, the strong discharge may be generated when a discharge between the A and Y electrodes is generated before a discharge between the X and Y electrodes. However, discharge between the X and Y electrodes may be generated before the discharge between the Y and A electrodes when the voltage of the Y electrode increases during the rising period of the reset period, such that a strong discharge during the reset period may be prevented.

Subsequently, still referring to FIG. 3, a light emitting cell and a non-light emitting cell may be selected in a corresponding subfield during the address period. As shown in FIG. 3, during the address period the sustain electrode driver 400 may maintain the voltage of the X electrode at the Ve voltage. Further, the scan electrode driver 500 may apply a scan pulse having a VscL voltage to the Y electrode, and the address electrode driver 300 may apply an address pulse having a Va voltage to the A electrode.

In addition, the scan electrode driver 500 may apply a VscH voltage, which is higher than the VscL voltage, to the Y electrode receiving the scan pulse. The reference voltage may be applied to A electrodes to which the address pulse is not applied. Thus, during the address period, the scan electrode driver 500 and the address electrode driver 300 may apply the scan pulse to a first row Y electrode Y1 shown in FIG. 1, and may apply the address pulse to the A electrode positioned in the light emitting cell in a first row.

An address discharge may be generated between the first row Y electrode Y1 shown in FIG. 1 and the A electrode receiving the address pulse. Thus, positive wall charges (+) may be formed on the Y electrode Y I shown in FIG. 1, and negative wall charges (−) may be formed on the A and X electrodes.

Subsequently, the scan electrode driver 500 may apply the scan pulse to a second row Y electrode Y2 shown in FIG. 1, and the address electrode driver 300 may apply the address pulse to the A electrode positioned on the light emitting cell of a second row. Thus, the address discharge may be generated in a cell corresponding to the A electrode receiving the address pulse and the second row Y electrode Y2 shown in FIG. 1, and wall charges may be formed in the cell. In a like manner, the scan electrode driver 500 may sequentially apply the scan pulse to remaining Y electrodes, and the address electrode driver 300 may apply the address pulse to the A electrodes positioned at light emitting cells to form the wall charges.

During the sustain period shown in FIG. 3, the scan electrode driver 500 may apply a sustain pulse alternately having a high level voltage (Vs in FIG. 3) and a low level voltage (0V in FIG. 3) to the Y electrode a number of times corresponding to a weight value of a corresponding subfield. In addition, the sustain electrode driver 500 may apply the sustain pulse to the X electrode with a phase that is opposite to the phase of the sustain pulse applied to the Y electrode. Thus, a voltage difference between the Y and X electrodes may alternate from Vs to −Vs, and a sustain discharge may be generated in the light emitting cell a predetermined number of times.

In another implementation (not shown), a sustain pulse alternately having the Vs voltage and the −Vs voltage may be applied to one of the Y electrode and the X electrode during the sustain period, while the 0V voltage may be applied to the other electrode. Thus, the voltage difference between the Y electrode and the X electrode may alternate from the Vs voltage to the −Vs voltage, and the sustain discharge may be generated in the light emitting cell.

An idle period may be arranged at a starting point of a frame (e.g., an n^{th} frame) that is subsequent to a finishing point of a previous frame (e.g., an n-1^{th} frame). During the idle period, the address electrode driver 300, the sustain electrode driver 400, and the scan electrode driver 500 may apply the 0V voltage to the A electrode, the X electrode, and the Y electrode, respectively, as shown in FIG. 3. The idle period may be a margin period for preventing an erroneous operation resulting from an abnormal period of the vertical synchronization signal V_sync.

Referring again to FIG. 2, since a driving time the reset, address, and sustain periods of one frame is preestablished, a long time may not be available for the preset period. Therefore, if a voltage waveform, i.e., a falling waveform, is applied to the Y electrode during a short preset period, the slope of the voltage waveform during the preset period may be steep. Thus, the desired effect of the preset period may be difficult to achieve.

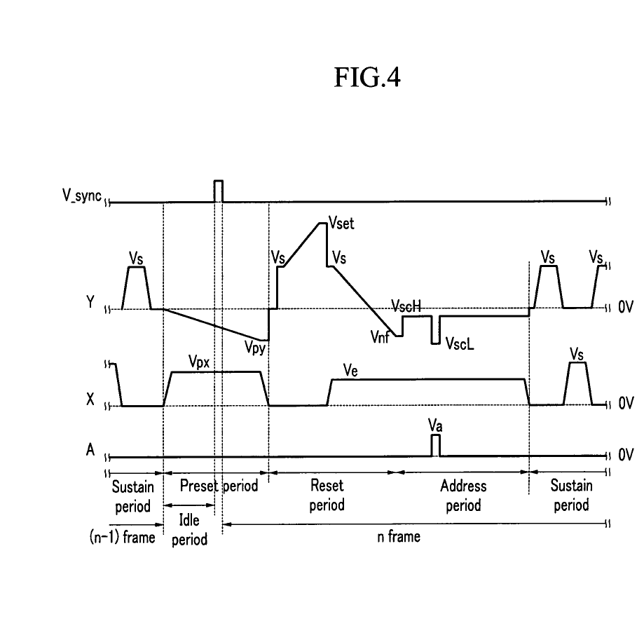

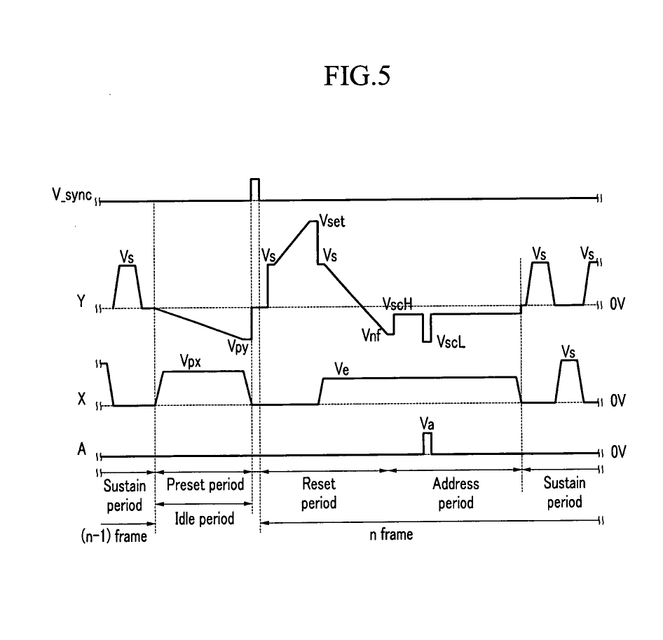

A method for stably performing the operation of the preset period according to an example embodiment will now be described with reference to FIGS. 4 and 5, which illustrates driving waveforms of the plasma display device shown in FIG. 1 wherein a falling waveform is applied to a Y electrode during an idle period and a preset period.

As shown in FIGS. 4 and 5, a falling waveform is applied to the Y electrode during the above-described idle period. That is, the above-described idle period is used to apply the falling waveform to the Y electrode, i.e., is overlapped with the falling waveform applied to the Y electrode.

As shown in FIG. 4, the idle period may be a part of the preset period for applying the falling waveform to the Y electrode. However, embodiments are not limited to this implementation, and the idle period may be a part of the preset period for applying the falling waveform to the Y electrode, or as shown in FIG. 5, when the idle period is set to be long enough, the idle period may be the same as the preset period for applying the falling waveform to the Y electrode.

During the preset period, the sustain electrode driver 400 applies the Vpx voltage to the X electrode and the scan electrode driver 500 gradually decreases the voltage of the Y electrode to the Vpy voltage. A slope of the falling waveform may be established to be gentle as the preset period becomes increased by the idle period, a stable preset operation may be performed. At this time, a slope of the falling waveform may be set to be gentler than a slope of the falling waveform in the reset period.

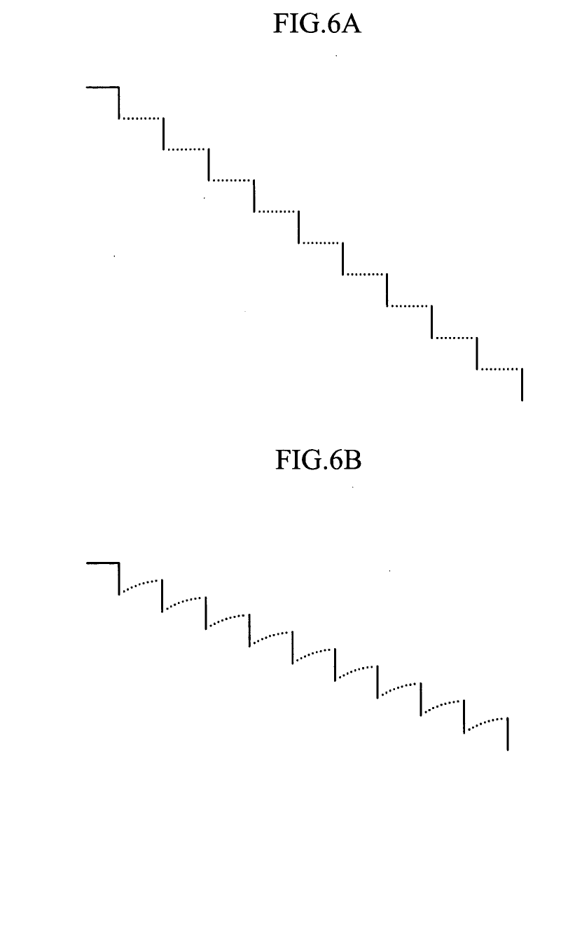

FIG. 6A and FIG. 6B illustrate diagrams of a falling waveform applied to the Y electrode when the Y electrode is periodically floated according to an embodiment.

According to an embodiment, as shown in FIG. 6A, the scan electrode driver 500 may decrease a voltage applied to the Y electrode by a predetermined level, and may repeatedly float the Y electrode to gradually decrease the voltage of the Y electrode to the Vpy voltage. For example, as shown in FIG. 6A, after the voltage applied to the Y electrode is decreased by the predetermined level, the voltage supplied to the Y electrode may be interrupted to float the Y electrode for a predetermined time. Subsequently, the voltage of the Y electrode may again be decreased by the predetermined level. The operation of floating the Y electrode for the predetermined time may be repeated a predetermined number of times.

When the voltage difference between the Y and X electrodes becomes greater than the discharge firing voltage while the Y electrode is repeatedly floated, a discharge may be generated between the Y electrode and the X electrode. No charges may be input to the Y electrode from the external power source when the Y electrode is floated after the discharge is generated between the Y electrode and the X electrode. Accordingly, the voltage of the Y electrode may vary according to the amount of wall charges. Further, a variation of the wall charge amount may directly decrease the voltage in a discharge cell. Accordingly, a lesser amount of wall charges may eliminate the strong discharge.

As set forth above, a cell may be initialized by a reset discharge during a reset period of each subfield. During the reset period, the voltage of the Y electrode may increase in a ramp pattern. A weak discharge may be generated between the Y and X electrodes, and between the Y and A electrodes, while the voltage of the Y electrode increases, such that negative wall charges (−) are formed on the Y electrode, and positive wall charges (+) are formed on the X and A electrodes. Subsequently, the X electrode voltage may be increased and the voltage of the Y electrode may be decreased in a ramp pattern. A weak discharge may be generated between the Y and X electrodes, and between the Y and A electrodes, while the voltage of the Y electrode decreases, such that the negative wall charges (−) formed on the Y electrode and the positive wall charges (+) formed on the X and A electrodes are eliminated. At this point, the voltage of the X electrode and the voltage of the Y electrode may be set so that a wall voltage between the Y and X electrodes is close to 0V.

Additionally, the wall charge state in non-selected cells may be maintained. Thus, a strong discharge may be generated during the reset period of a subsequent subfield, since a discharge between the A and Y electrodes may be generated before a discharge between the X and Y electrodes. Therefore, during the preset period, which is arranged before the reset period, a Vpx voltage higher than the Ve voltage is applied to the X electrode, and the voltage of the Y electrode may be gradually decreased from 0V to a Vpy voltage. The voltage difference (Vpx−Vpy) during the preset period may be set to be greater than the voltage difference (Ve−Vnf) during the subsequent reset period. Therefore, when the voltage of the Y electrode increases to Vset during the reset period, discharge between the X and Y electrodes may be generated before a discharge occurs between the Y and A electrodes, such that a strong discharge during the reset period may be prevented.

If the preset period is not sufficiently long, then the slope of the decreasing voltage applied to the Y electrode during the preset period may be steep. Therefore, according to the embodiments described above, the decreasing voltage applied to the Y electrode may begin earlier, such that it overlaps with the V_sync pulse. Additionally, the X electrode may be biased to a non-zero voltage, e.g., Vpx, earlier, such that the bias voltage also overlaps with the V_sync pulse.

The wall charges formed on the Y and X electrodes may be reduced and the voltage in the discharge space may decrease sharply when a discharge is generated by the decrease of the voltage of the Y electrode, such that the strong discharge may be eliminated. Further, when the Y electrode is floated after the discharge, the wall charges may be reduced and the strong discharge may be eliminated in the discharge space. When the above operation is repeatedly performed, the wall charges may be eliminated while the discharge firing voltage is maintained. Therefore, the wall charges in the cell may be precisely controlled.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a frame of plasma display device having a first electrode, a second electrode, and an address electrode, the method comprising:
gradually decreasing a voltage of the second electrode from a second voltage to a third voltage and, while decreasing the voltage of the second electrode, applying a first voltage to the first electrode during a first period;
after the voltage of the second electrode reaches the third voltage, gradually increasing the voltage of the second electrode from a fifth voltage to a sixth voltage while a fourth voltage is applied to the first electrode during a second period; and
after the voltage of the second electrode reaches the sixth voltage, gradually decreasing the voltage of the second electrode from an eighth voltage to a ninth voltage while a seventh voltage is applied to the first electrode during a third period, wherein:
an absolute value of the difference between the first voltage and the third voltage is greater than an absolute value of the difference between the seventh voltage and the ninth voltage, and
a fourth period between a point of time for finishing a sustain period of a last subfield of a first frame and a starting point of a vertical synchronization signal for a second frame that is subsequent to the first frame is overlapped with the first period.

2. The method as claimed in claim 1, wherein the fourth period comprises a part of the first period.

3. The method as claimed in claim 2, wherein the fourth period comprises the first period.

4. The method as claimed in claim 1, wherein the voltage of the second electrode is at the third voltage during the vertical synchronization pulse.

5. The method as claimed in claim 1, wherein a slope of the voltage decrease from the second voltage to the third voltage is less than a slope of the voltage decrease from the eight voltage to the ninth voltage.

6. The method as claimed in claim 1, further comprising intermittently floating the second electrode while decreasing the voltage of the second electrode from the second voltage to the third voltage.

7. The method as claimed in claim 1, further comprising, after the voltage of the second electrode reaches the ninth voltage, applying a scan pulse to the second electrode while applying an address pulse to the address electrode.

8. A plasma display device, comprising:
a first electrode, a second electrode, and an address electrode;
a controller configured to drive a frame and to provide a vertical synchronization pulse indicating a start of the frame; and
one or more drivers configured to drive the first electrode, the second electrode, and the address electrode, wherein:
a voltage of the second electrode gradually decreases from a second voltage to a third voltage and, while the voltage of the second electrode decreases, a first voltage is applied to the first electrode during a first period,
after the voltage of the second electrode reaches the third voltage, the voltage of the second electrode gradually increases from a fifth voltage to a sixth voltage while a fourth voltage is applied to the first electrode,
after the voltage of the second electrode reaches the sixth voltage, the voltage of the second electrode gradually decreases from an eighth voltage to a ninth voltage while a seventh voltage is applied to the first electrode, an absolute value of the difference between the first voltage and the third voltage is greater than an absolute value of the difference between the seventh voltage and the ninth voltage, and
a second period between a point of time for finishing a sustain period of a last subfield of a first frame and a starting point of a vertical synchronization pulse for a second frame that is subsequent to the first frame is overlapped with the first period.

9. The device as claimed in claim 8, wherein the second period comprises a part of the first period.

10. The device as claimed in claim 9, wherein the second period comprises the first period.

11. The device as claimed in claim 8, wherein the voltage of the second electrode is at the third voltage during the vertical synchronization pulse.

12. The device as claimed in claim 8, wherein a slope of the voltage decrease from the second voltage to the third voltage is less than a slope of the voltage decrease from the eight voltage to the ninth voltage.

13. The device as claimed in claim 8, wherein the second electrode is intermittently floating while decreasing the voltage of the second electrode from the second voltage to the third voltage.

14. The device as claimed in claim 8, wherein, after the voltage of the second electrode reaches the ninth voltage, a scan pulse is applied to the second electrode while applying an address pulse to the address electrode.

15. A plasma display device, comprising:
a discharge cell;
a controller configured to drive a frame and to provide a vertical synchronization pulse for the frame; and
one or more drivers configured to apply a reset waveform to the discharge cell during a reset period of an initial subfield of the frame, and to apply a predetermined waveform to the discharge cell during a first period before the reset period, wherein:
a third wall charge on the discharge cell is eliminated after a first wall charge is formed on the discharge cell by the predetermined waveform,
a second wall charge is formed on the discharge cell by the reset waveform when the discharge cell is sustain discharged in a last subfield of an immediately preceding frame, and
a second period before the vertical synchronization signal for the first frame overlaps with the first period.

16. The device as claimed in claim 15, wherein:
a first electrode, a second electrode, and an address electrode correspond to the discharge cell,
the predetermined waveform includes:
a gradual decrease in a voltage of the second electrode from a second voltage to a third voltage, a first voltage being applied to the first electrode while the voltage of the second electrode decreases during a first period.

17. The device as claimed in claim 16, wherein the second period comprises a part of the first period.

18. The device as claimed in claim 17, wherein the second period comprises the first period.

19. The device as claimed in claim 16, wherein the voltage of the second electrode is at the third voltage during the vertical synchronization pulse.

20. The device as claimed in claim 16, wherein during the reset period,
after the voltage of the second electrode reaches the third voltage, a gradual increase in the voltage of the second electrode from a fifth voltage to a sixth voltage while a fourth voltage is applied to the first electrode; and
after the voltage of the second electrode reaches the sixth voltage, a gradual decrease in the voltage of the second electrode from an eighth voltage to a ninth voltage while a seventh voltage is applied to the first electrode, an absolute value of the difference between the first voltage and the third voltage being greater than an absolute value of the difference between the seventh voltage and the ninth voltage, and
a slope of the voltage decrease from the second voltage to the third voltage is less than a slope of the voltage decrease from the eight voltage to the ninth voltage.
